(19) United States
(12) Patent Application Publication
(10) Pub. No.: US 2018/0190298 A1
(43) Pub. Date: Jul. 5, 2018

(54) BABY CRY DETECTION CIRCUIT AND ASSOCIATED DETECTION METHOD

(71) Applicant: MStar Semiconductor, Inc., Hsinchu Hsien (TW)

(72) Inventors: Hung-pin Huang, Hsinchu Hsien (TW); Jian-tai Chen, Hsinchu Hsien (TW); Hao-teng Fan, Hsinchu Hsien (TW)

(21) Appl. No.: 15/610,756

(22) Filed: Jun. 1, 2017

(30) Foreign Application Priority Data
Jan. 4, 2017 (TW) 106100121

(51) Int. Cl. G10L 17/26; G10L 25/21; G10L 25/45; G10L 17/20; G10L 25/18

(52) U.S. Cl. CPC G10L 17/26; G10L 25/21; G10L 25/18; G10L 17/20; G10L 25/45

(57) ABSTRACT

A baby cry detection circuit includes a signal capturing circuit, a characteristics capturing circuit and a determination circuit. When a strength of a voice signal is greater than a threshold, the signal capturing circuit captures the voice signal to generate a voice segment signal. A time period of a voice segment corresponding to the voice segment signal is within a predetermined range. The characteristics retrieving circuit, coupled to the signal capturing circuit, captures a plurality of characteristic values of the voice segment signal. The determination circuit, coupled to the characteristics capturing circuit, determines whether the voice segment corresponding to the voice segment signal is a baby cry according to the characteristic values.

This application claims the benefit of Taiwan application Serial No. 106100121, filed Jan. 4, 2017, the subject matter of which is incorporated herein by reference.

### BACKGROUND OF THE INVENTION

### Field of the Invention

The invention relates in general to voice detection, and more particularly to a baby cry detection circuit and an associated detection method.

### Description of the Related Art

Current baby cry monitoring devices usually determine whether there is a baby cry according to the strength of a voice received. For example, a baby monitoring device determines whether the strength of a voice signal received is greater than a constant threshold, and determines that the voice signal is a baby cry when the strength is greater than the threshold and issues an alert signal to the parents. However, the above method of determining the presence of a baby cry may be affected by ambient sounds, which may lead to a misjudgment.

### SUMMARY OF THE INVENTION

An object of the present invention is to provide a baby cry detection circuit and an associated detection method. The circuit and method divide a received voice signal to generate multiple segments according to cry characteristics of a baby cry, and capture and compare characteristic values of each of the voice segments, so as to accurately determine whether the received voice signal is a baby cry to solve issues of the prior art.

A baby cry detection circuit is disclosed according to an embodiment of the present invention. The baby cry detection circuit includes a signal capturing circuit, a characteristics capturing circuit and a determination circuit. The signal capturing circuit captures a voice signal to generate a voice segment signal when the strength of the voice signal is greater than a threshold. A time period of a voice segment corresponding to the voice segment signal is within a predetermined range. The characteristics capturing circuit, coupled to the signal capturing circuit, captures a plurality of characteristic values of the voice segment signal. The determination circuit, coupled to the characteristics capturing circuit, determines whether the voice segment corresponding to the voice segment signals is a baby cry according to the characteristic values.

A baby cry detection method is disclosed according to another embodiment of the present invention. The baby cry detection method includes: when the strength of a voice signal is greater than a threshold, capturing the voice signal to generate a voice segment signal, wherein a time period of a voice segment corresponding to the voice segment signal is within a predetermined range; capturing a plurality of characteristic values of the voice segment signal; and determining whether the voice segment corresponding to the voice segment signal is a baby cry according to the characteristic values.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a baby cry detection circuit according to an embodiment of the present invention;

FIG. 2 is a block diagram of a preprocessing circuit according to an embodiment of the present invention;

FIG. 3 is a schematic diagram of a signal capturing circuit capturing a voice signal in a segmented manner to generate a voice segment signal;

FIG. 4 is a block diagram of a characteristics capturing circuit according to an embodiment of the present invention;

FIG. 5 is an example of a plurality of audio frames in a characteristics capturing circuit and a plurality of corresponding characteristic parameters and characteristic values; and

FIG. 6 is a flowchart of a baby cry detection method according to an embodiment of the present invention.

### DETAILED DESCRIPTION OF THE INVENTION

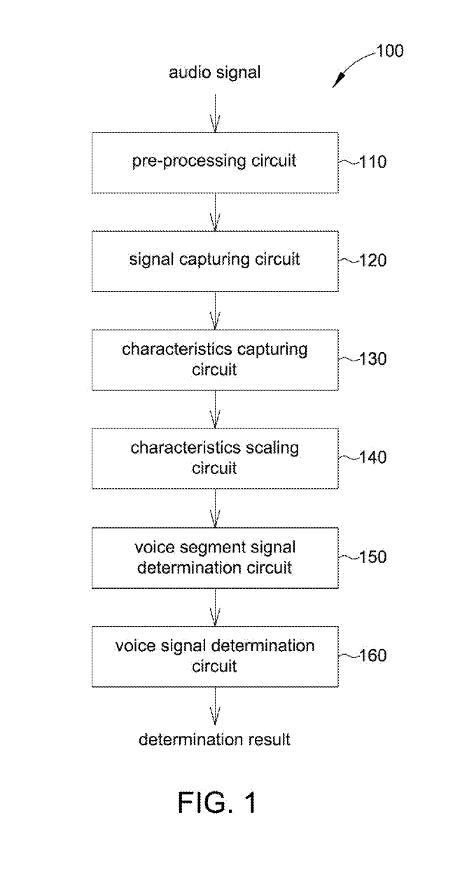

FIG. 1 shows a block diagram of a baby cry detection circuit 100 according to an embodiment of the present invention. As shown in FIG. 1, the baby cry detection circuit 100 includes a preprocessing circuit 110, a signal capturing circuit 120, a characteristics capturing circuit 130, a characteristics scaling circuit 140, a voice segment signal determination circuit 150 and a voice signal determination circuit 160. In this embodiment, the baby cry detection circuit 100 may be disposed in any electronic device, which detects a baby cry and is placed in an ambient environment of a baby. When the electronic device has detected a baby cry, it transmits an alert signal through wireless transmission to another electronic device to inform the parents or the baby caretaker.

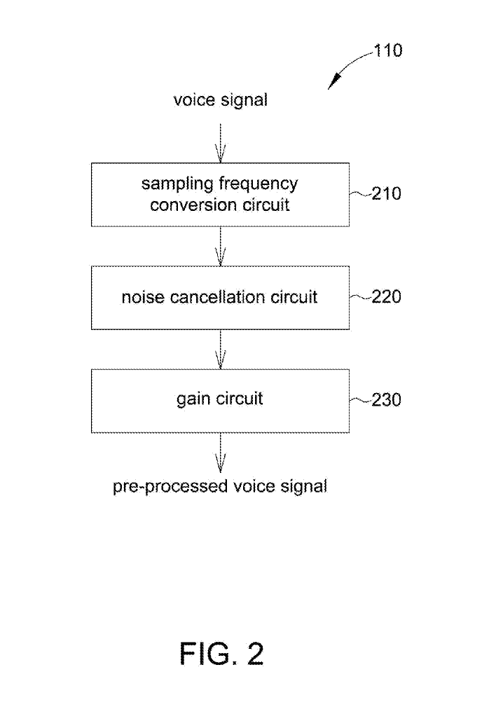

In the baby cry detection device 100, the preprocessing circuit 110 preprocesses a voice signal received. More specifically, FIG. 2 shows a block diagram of the preprocessing circuit 110 according to an embodiment of the present invention. Referring to FIG. 2, the preprocessing circuit 110 includes a sampling frequency conversion circuit 210, a noise cancellation circuit 220 and a gain circuit 230. Voice signals received by different baby cry detection circuits 100 may be in different frequencies or may include multiple different frequencies. Thus, to adapt to different baby cry detection circuits 100, the sampling frequency conversion circuit 210 converts a sampling frequency of the voice signal received, e.g., sampling the voice signal according to a constant sampling frequency (8 kHz) to generate a sampling frequency converted voice signal. In another embodiment, a predetermined baby cry detection circuit 100 may be directly selected. At this point, the preprocessing circuit 110 does not require the sampling frequency conversion circuit 210. The noise cancellation circuit 220 performs noise cancellation on the sampling frequency converted voice signal to generate a noise cancelled voice signal. The gain circuit 230 performs gain adjustment on the noise cancelled voice signal to generate a preprocessed voice signal. In practice, the orders of the noise cancellation circuit 220 and the gain circuit 230 may be swapped. Further, given that less satisfactory processing effects can be tolerated, the gain circuit 230 may be eliminated.

The preprocessing circuit 110 in FIG. 1 is an optional component. That is, in an alternative embodiment of the present invention, the preprocessing circuit 110 may be eliminated from the baby cry detection circuit 110, and the voice signal is directly captured by the signal capturing circuit 120.

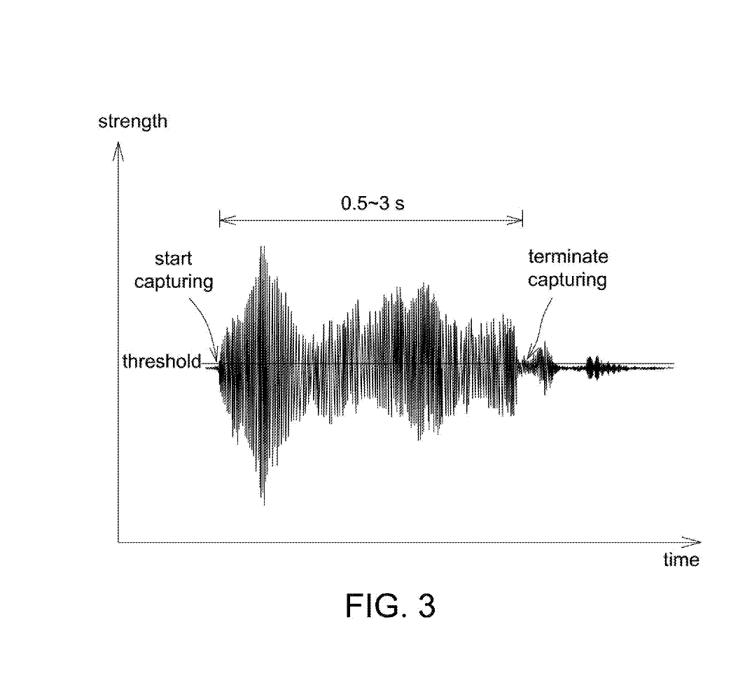

Again referring to FIG. 1, the signal capturing circuit 120 captures a segment of the preprocessed voice signal. More specifically, the capturing circuit 120 detects whether the strength of the preprocessed signal is greater than a threshold. When it is detected that the strength of the preprocessed voice signal is greater than the threshold, the capturing circuit 120 captures a segment of the preprocessed voice signal to obtain a voice segment signal from the preprocessed voice signal. The voice segment signal corresponds to a voice segment, and a time period of the voice segment is within a predetermined range. In the embodiment, based on characteristics of baby cries, the predetermined range is between 0.5 s and 3 s. More specifically, referring to FIG. 3, when the signal capturing circuit 120 detects that the strength of the preprocessed voice signal is greater than the threshold, the signal capturing circuit 120 starts capturing the preprocessed voice signal until the strength of the preprocessed voice signal is lower than the threshold or the capturing time reaches an upper limit of the predetermined range (e.g., 3s in this embodiment) to generate a voice segment signal. In another embodiment of the present invention, if the strength of the preprocessed voice signal remains higher than the threshold for a long period of time (e.g., greater than 3 s), the signal capturing circuit 120 first captures a voice segment signal (a voice segment corresponding to a time period of 3 s), and immediately again captures a next voice segment signal from the preprocessed voice signal.

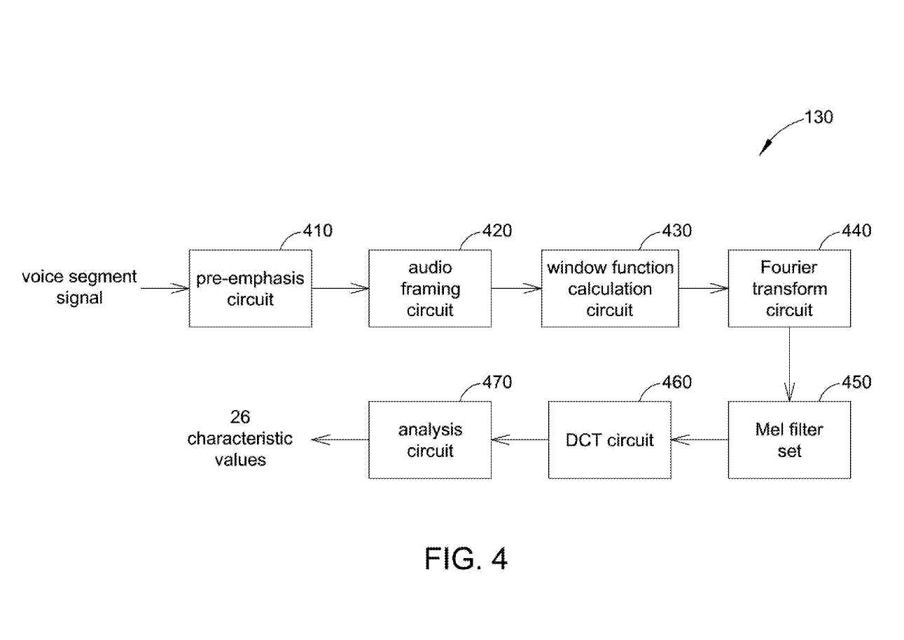

The characteristics capturing circuit 130 captures multiple characteristic values of each voice segment signal. More specifically, referring to FIG. 4, the characteristics capturing circuit 130 according to an embodiment of the present invention includes a pre-emphasize circuit 410, an audio framing circuit 420, a window function calculation circuit 430, a Fourier transform circuit 440, a Mel filter set 450, a discrete cosine transform (DCT) circuit 460, and an analysis circuit 470. In an operation of the characteristics capturing circuit 130, the pre-emphasis circuit 410 performs a high-pass filter operation on the voice segment signal to generate a pre-emphasized signal. The operation of the pre-emphasis circuit 410 may be illustrated using the example: x′[n]=x[n]−0.97x[n−1], where x[n] is an input of the pre-emphasis circuit 410, and x′[n] is an output of the pre-emphasis circuit 410. During the process of sound making by a maker (e.g., a baby) of the voice signal to receiving the voice signal by a sound receiving device (e.g., the baby cry detection circuit 100), energy of high-frequency components in the voice signal attenuates as the frequency increases. Thus, a part of the attenuation is compensated through the high-pass filter operation, or, alternatively speaking, resonance peaks of high frequencies are emphasized. The audio framing circuit 420 retrieves multiple audio frames from the pre-emphasized signal. For example, from the pre-emphasized signal (corresponding to one voice segment), the audio framing circuit 420 retrieves multiple audio frames (each of which corresponding to multiple sampling points) having a time period of 20 ms to 40 ms. Further, to prevent an excessively large change between two adjacent audio frames, adjacent audio frames are caused to be partially overlapping. Next, the window function calculation circuit 430 multiples each of the audio frames by a window function to generate multiple window functionalized audio frames. An operation of the window function calculation circuit 430 may be illustrated by an example: y[n]=x′[n]*w[n], where y[n] is an output of the window function calculation circuit 430, and w[n] is a function. In an embodiment, the window function

$$w [ n ] = 0.54 - 0.46 cos ( \frac{2 π n}{N - 1} ) , 0 \leq n \leq N .$$

More specifically, the audio framing circuit 420 processes the signal into audio frames each having a constant length, so the audio frames are easy to process. However, because original amplitude values are kept the signal in the audio frames and the signal outside the audio frames is set to 0, a discontinuity issue is caused. Such discontinuity issue is effectively eliminated by the operation of the window function calculation circuit 430. For example, by incorporating a feature of a Hamming window function capable of preserving a middle part of the signal and suppressing values at two ends, with the overlapping adjacent audio frames, the discontinuity at borders of the audio frames may be effectively alleviated. The Fourier transform circuit 440 performs a discrete Fourier transform to generate multiple Fourier transformed audio frames. An operation of the Fourier transform circuit 440 may be illustrated by an example: Y(e^{jw})=|Σₙ₋₀^{N-1}y[n]e^{-jwn}|. The Mel filter set 450 filters the Fourier transformed audio frames to generate multiple filtered audio frames. An operation of the Mel filter set 450 may be illustrated by an example:

$$Mel [ f ] = 2595 {log}_{10} ( 1 + \frac{f}{700} ) .$$

More specifically, the Mel filter set 450 includes M triangular bandpass filters, which are evenly distributed on Mel frequencies to simulate hearing properties of the human ear. After energy spectra of the multiple window functionalized audio frames having been Fourier transformed are filtered by the M triangular bandpass filters, respectively, the energy distributed on each of the Mel frequencies can be obtained. The discrete cosine transform circuit 460 performs discrete cosine transform on the multiple filtered audio frames to generate multiple characteristic parameters (e.g., Mel ceptral coefficients) of each of the audio frames. The analysis circuit 470 generates the multiple characteristic values of the captured signal according to the multiple characteristic parameters of each of the audio frames.

The pre-emphasis circuit 410 and the window function calculation circuit 430 in FIG. 4 are optional components. That is, in an alternative embodiment of the present invention, the pre-emphasis circuit 410 and/or the window function calculation 430 may be eliminated from the characteristics capturing circuit 130.

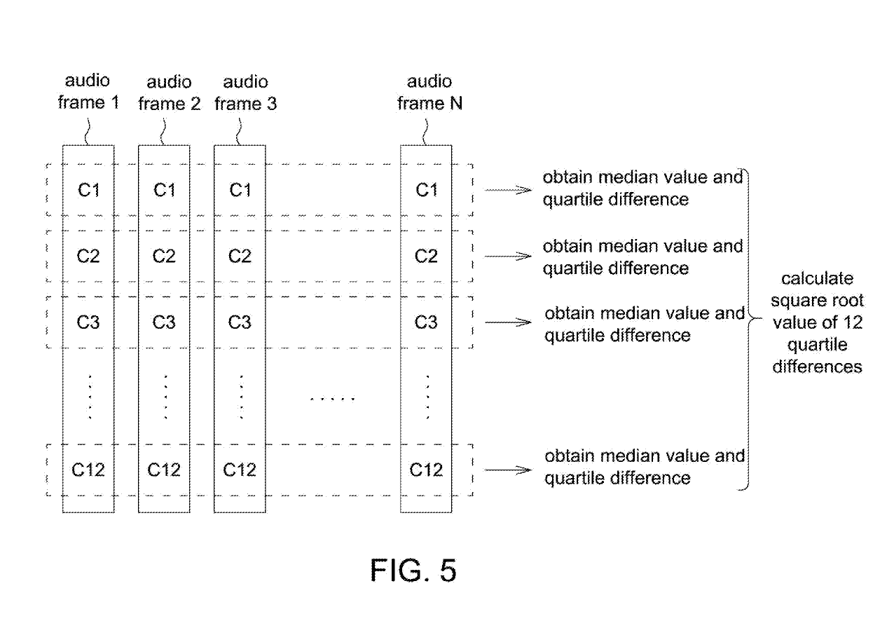

FIG. 5 shows an example of a plurality of audio frames as well as a plurality of characteristic parameters and a plurality of characteristic values corresponding to the audio frames. Referring to FIG. 5, assuming that N audio frames are captured from the voice segment signal, and each of the audio frames has 12 characteristic parameters C1 to C12. At this point, the analysis circuit 470 statistically calculates the characteristic parameters of the audio frames numbered by the same numerals to obtain a median number and a quartile difference corresponding to each of the characteristic parameters C1 to C12; that is, 12 median numbers and 12 quartile differences are obtained. Further, the 12 median values, the 12 quartile differences, a square root value of the 12 quartile differences and the number (e.g., N) of the audio frames retrieved from the voice segment signal, may serve as 26 characteristic parameters as an output of the characteristics capturing circuit 130.

Again referring to FIG. 1, the characteristics scaling circuit 140 performs a scaling operation on the characteristic values (e.g., the foregoing 26 characteristics value) corresponding to the same voice segment signal to maintain the stability of a value range, and generates scaled characteristic values. The voice segment signal determination circuit 150 performs an algorithm on the scaled characteristic values (e.g., the foregoing 26 characteristics value) corresponding to the same voice segment signal according to a support vector machines (SVM) algorithm to determine whether the voice segment corresponding to the voice segment signal is a baby cry. In one embodiment, the SVM algorithm is an SVM algorithm having a radial basis function (RBF) core. More specifically, at a factory end, an engineer first enters training data into an SVM learning module to determine multiple support vectors on a hyperplane as an SVM model. The SVM model is a set established with two maximum margins in a two-dimensional plane. In practice, the voice segment signal determination circuit 150 determines to which set the scaled characteristic values (e.g., foregoing 26 characteristics value) corresponding to the same voice segment signal belong, and accordingly determines whether the voice segment corresponding to the voice segment signal is a baby cry.

The characteristics scaling circuit 140 is an optional component. That is, in an alternative embodiment of the present invention, the characteristics scaling circuit 140 may be eliminated.

The voice signal determination circuit 160 determines whether the voice signal is a baby cry according to a sensitivity setting and at least one determination result of the voice segment determination circuit. For example, when the baby cry detection circuit 100 is set with a high sensitivity, the voice signal determination circuit 160 determines that the voice signal is a baby cry given that at least one voice segment signal is determined as a baby cry, and the baby cry detection circuit 100 accordingly sends an alert signal to the parents or the baby caretaker. When the baby cry detection circuit 100 is set with a medium sensitivity, and at least two out of five consecutive voice segment signals are determined as baby cries, the voice signal determination circuit 160 determines that the baby signal is a baby cry. When the baby cry detection circuit 100 is set with a low sensitivity, when at least three out of five consecutive voice segment signals are determined as baby cries, the voice signal determination circuit 150 determines that the voice signal is a baby cry.

The voice segment signal determination circuit 150 and the voice signal determination circuit 160 in FIG. 1 are provided based on the consideration of sensitivity. Thus, in one embodiment, the voice segment signal determination circuit 150 is capable of determining whether the voice signal is a baby cry, and so the voice signal determination circuit 160 may be eliminated from the baby cry detection circuit 100. In another embodiment, the voice segment signal determination circuit 150 and the voice signal determination circuit 160 may be implemented in the same circuit module.

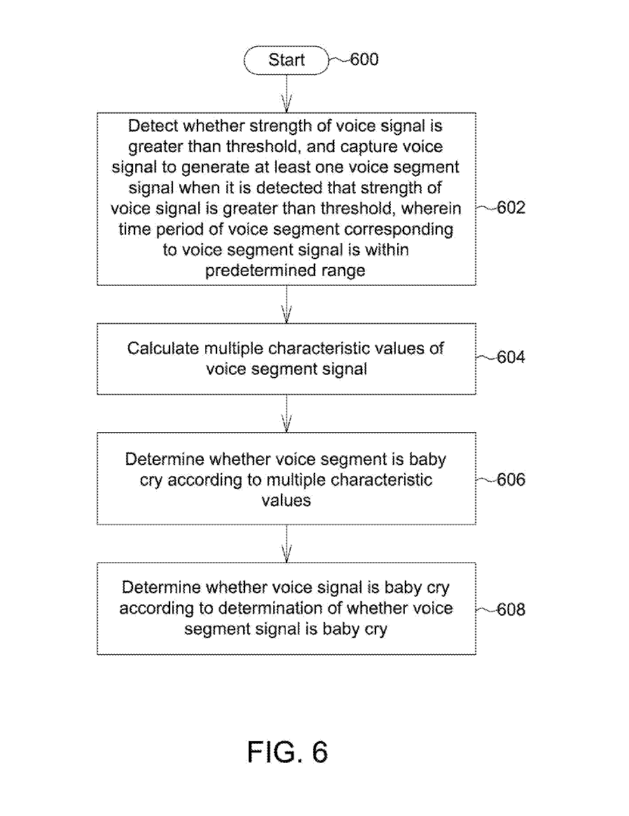

FIG. 6 shows a flowchart of a baby cry detection method. Referring to the description associated with the embodiments in FIG. 1 to FIG. 5, the process in FIG. 6 includes following steps.

In step 600, the process begins.

In step 602, it is detected whether the strength of a voice signal is greater than a threshold, and the voice signal is captured to generate at least one voice segment signal when the strength of the voice signal is detected as being greater than the threshold. A time period of the voice segment corresponding to the voice segment signal is within a predetermined range.

In step 604, multiple characteristic values of the voice segment signal are calculated.

In step 606, it is determined whether the voice segment signal is a baby cry according to the multiple characteristic values.

In step 608, it is determined whether the voice signal is a baby cry according to the determination result of whether the voice segment signal is a baby cry.

In conclusion, in the baby cry detection circuit and associated method of the present invention, characteristics of a baby cry are referred to capture a voice signal received in a segmented manner to generate multiple voice segment signals. The time period of each of the voice segment signals is within a predetermined range, e.g., 0.5 s to 3 s. The characteristic values of each of the voice segment signals are then captured and compared to accurately determine whether the voice signal received is a baby cry. Thus, the present invention is capable of reducing effects of sounds in the ambient environment to enhance the accuracy of baby cry detection and determination.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A baby cry detection circuit, comprising:
a signal capturing circuit, capturing a voice signal to generate a voice segment signal when a strength of the voice signal is greater than a threshold, wherein a time period of a voice segment corresponding to the voice segment signal is within a predetermined range;
a characteristics capturing circuit, coupled to the signal capturing circuit, capturing a plurality of characteristic values of the voice segment signal; and
a determination circuit, coupled to the characteristics capturing circuit, determining whether the voice segment corresponding to the voice segment signal is a baby cry according to the characteristic values.

2. The baby cry detection circuit according to claim 1, wherein when the strength of the voice signal is greater than the threshold, the signal capturing circuit starts capturing the voice signal until the strength of the voice signal is lower than the threshold or when a capturing period reaches an upper limit of the predetermined range to generate the voice segment signal.

3. The baby cry detection circuit according to claim 2, wherein when the signal capturing circuit generates the voice segment signal because the capturing period reaches the upper limit of the predetermined range, the signal capturing circuit starts capturing a next voice segment signal from a time point at which the capturing period reaches the upper limit of the predetermined range.

4. The baby cry detection circuit according to claim 1, wherein the predetermined range is 0.5 second to 3 seconds.

5. The baby cry detection circuit according to claim 1, further comprising:
a preprocessing circuit, preprocessing the voice signal to generate a preprocessed signal to the signal capturing circuit, the preprocessing circuit comprising:
a sampling frequency conversion circuit, sampling the voice signal according to a constant sampling frequency to generate a sampling frequency converted voice signal;
a noise cancellation circuit, coupled to the sampling frequency conversion circuit, performing noise cancellation on the sampling frequency converted voice signal to generate a noise cancelled voice signal; and
a gain circuit, coupled to the noise cancellation circuit, performing gain adjustment on the noise cancelled voice signal to generate the preprocessed voice signal.

6. The baby cry detection circuit according to claim 1, wherein the characteristics capturing circuit comprises:
an audio framing circuit, retrieving a plurality of audio frames from the voice segment signal;
a Fourier transform circuit, performing Fourier transform on the audio frames to generate a plurality of Fourier transformed audio frames;
a filter set, filtering the Fourier transformed audio frames to generate a plurality of filtered audio frames;
a discrete cosine transform circuit, performing discrete cosine transform on the filtered audio frames to generate a plurality of characteristic parameters corresponding to each of the audio frames; and
an analysis circuit, generating the characteristic values of the audio segment signal according to the characteristic parameters corresponding to each of the audio frames.

7. The baby cry detection circuit according to claim 6, wherein the characteristics capturing circuit further comprises:
a window function calculation circuit, processing the audio frames to generate a plurality of window functionalized audio frames according to a window function;
wherein, the Fourier transform circuit performs the Fourier transform on the window functionalized audio frames to generate the Fourier transformed audio frames.

8. The baby cry detection circuit according to claim 6, wherein the characteristics capturing circuit further comprises:
a pre-emphasis circuit, performing a high-pass filter operation on the audio frames to generate a pre-emphasized signal;
wherein, the audio framing circuit retrieves the audio frames from the pre-emphasized signal.

9. The baby cry detection circuit according to claim 1, wherein the characteristics capturing circuit comprises:
an audio framing circuit, retrieving a plurality of audio frames from the voice segment signal;
wherein, the determination circuit determines whether the voice segment corresponding to the voice segment signal is a baby cry according to a plurality of median values of the characteristic values, a plurality of quartile differences of the characteristic values and the number of the audio frames.

10. The baby cry detection circuit according to claim 1, wherein the determination circuit applies a support vector machines (SVM) algorithm to determine whether the voice segment corresponding to the voice segment signal is a baby cry according to the characteristic values.

11. The baby cry detection circuit according to claim 10, wherein the SVM algorithm is an SVM algorithm having a radial basis function (RBF).

12. The baby cry detection circuit according to claim 1, wherein the signal capturing circuit further captures the voice signal to generate another voice segment signal when the strength of the voice signal is greater than the threshold, the another voice segment signal and the voice signal correspond to different voice segments, the determination circuit is a first determination circuit, and the first determination circuit further determines whether the voice segment corresponding to the another voice segment signal is a baby cry; the baby cry detection circuit further comprises:
a second determination circuit, coupled to the first determination circuit, determining whether a voice corresponding to the voice signal is a baby cry according to the determination results determined by the first determination circuit.

13. A baby cry detection method, comprising:
capturing a voice signal to generate a voice segment signal when a strength of the voice signal is greater than a threshold, wherein a time period of a voice segment corresponding to the voice segment signal is within a predetermined range;
capturing a plurality of characteristic values of the voice segment signal; and
determining whether the voice segment corresponding to the voice segment signal is a baby cry according to the characteristic values.

14. The baby cry detection method according to claim 13, wherein the step of capturing the voice signal to generate the voice segment signal comprises:
when the strength of the voice signal is greater than the threshold, starting capturing the voice signal until the strength of the voice signal is lower than the threshold or when a capturing period reaches an upper limit of the predetermined range to generate the voice segment signal.

15. The baby cry detection method according to claim 14, wherein the step of capturing the voice signal to generate the voice segment signal further comprises:
when the voice segment signal is generated because the capturing period reaches the upper limit of the predetermined range, starting capturing a next voice segment signal from a time point at which the capturing period reaches the upper limit of the predetermined range.

16. The baby cry detection method according to claim 13, further comprising:
sampling the voice signal according to a constant sampling frequency to generate a sampling frequency converted voice signal;
performing noise cancellation on the sampling frequency converted voice signal to generate a noise cancelled voice signal; and
performing gain adjustment on the noise cancelled voice signal to generate the preprocessed voice signal;
wherein, the step of capturing the voice signal to generate the voice segment signal captures the preprocessed voice signal to generate the voice segment signal.

17. The baby cry detection method according to claim 13, wherein the step of capturing the characteristic values from the voice segment signal comprises:
retrieving a plurality of audio frames from the voice segment signal;
performing Fourier transform on the audio frames to generate a plurality of Fourier transformed audio frames;
filtering the Fourier transformed audio frames to generate a plurality of filtered audio frames;
performing discrete cosine transform on the filtered audio frames to generate a plurality of characteristic parameters corresponding to each of the audio frames; and
generating the characteristic values of the audio segment signal according to the characteristic parameters corresponding to each of the audio frames.

18. The baby cry detection method according to claim 13, wherein the step of capturing the characteristic values from the voice segment comprises:
retrieving a plurality of audio frames from the voice segment signals, wherein the characteristic values respectively correspond to the audio frames;
wherein, the step of determining whether the voice segment corresponding to the voice segment signal is a baby cry according to the characteristic values comprises determining whether the voice segment corresponding to the voice segment signal is a baby cry according to a plurality of median values of the characteristic values, a plurality of quartile differences of the characteristic values and the number of the audio frames.

19. The baby cry detection method according to claim 13, wherein the step of determining whether the voice segment is a baby cry according to the characteristic values comprises:
applying a support vector machines (SVM) algorithm to determine whether the voice segment corresponding to the voice segment signal is a baby cry according to the characteristic values.

20. The baby cry detection method according to claim 13, further comprising:
capturing the voice signal to generate another voice segment signal when the strength of the voice signal is greater than the threshold, wherein the another voice segment signal and the voice signal correspond to different voice segments;
determining whether an another voice segment corresponding to the another voice segment signal is the baby cry; and
determining whether a voice corresponding to the voice signal is a baby cry according to the determination results of the voice segment signal and the another voice segment signal.
